(19) United States
(12) Patent Application Publication
(10) Pub. No.: US 2005/0263112 A1
(43) Pub. Date: Dec. 1, 2005

(54) Rotational engine structure

(76) Inventor: Yu Tzu Wei, Feng Shan City (TW)

Correspondence Address: Yu Tzu Wei, PO Box 82-144, Taipei, TW

(21) Appl. No.: 10/856,879

(22) Filed: Jun. 1, 2004

(51) Int. Cl. F02B 53/00; F02M 1/00

(52) U.S. Cl. 123/45 R

(57) ABSTRACT

A rotational engine structure is disclosed. The rotational engine comprises a cylinder seat body, a cylinder seat, a piston and a cap body. The interior of the cylinder seat body is an oval rail having a hole for the shaft of the cylinder seat to pass through. The cylinder seat has two parallel circular paths having an air hole. A valve body is provided to the air hole, and the top section of the cylinder seat is a cylinder seat cover and the piston is positioned within the two paths. The external end face of the piston is a recess for mounting to a rotating wheel.

### BACKGROUND OF THE INVENTION

(a) Technical Field of the Invention

The present invention relates to an engine, and in particular to a rotational engine which allows the cylinder seat to rotate about a shaft center.

(b) Description of the Prior Art

Taiwan Patent Publication No. 144952 discloses an engine comprising a fixed rotor, a hollow rotating body which rotates about the rotor. Taiwan Patent Publication No. 165543 discloses a loop engine having a compression section containing a compression chamber for compressed mixed air-fuel before it is discharged.

Taiwan Patent Publication No. 170753 discloses a rotational engine having a large cylindrical chamber which comprises an air inlet chamber and a housing for a combustion chamber.

Taiwan Patent Publication No. 165543 and 170753 employs a spring to connect the cylinder and the piston. The spring will become fatigued and maintenance is needed. Thus, it is an object of the present invention to provide a rotational engine structure which can mitigate the above drawbacks.

### SUMMARY OF THE INVENTION

Accordingly, it is an object of the present invention to provide a rotational engine having a cylinder seat body, cylinder seat, piston and a cap body, characterized in that the interior of the cylinder seat body is recessed to provide an oval shape rail seat having a through hole for the mounting of a shaft of the cylinder seat, the cylinder seat is circular having a bottom section downwardly extended to form a shaft which can be inserted into a hole on the rail seat to connect to a transmission element, the surrounding of the shaft center of the cylinder seat is extended to provide two circular paths in parallel and the inner end of the path is provided with an air hole respectively mounted with a valve body, the valve body has a hole which corresponds to the air hole, and the interior of the valve body is provided with a retractable blocking rod which can extend to the left and right or be retracted to block or open the hole to allow air or discharged air of the two air holes, the center position of the two paths is provided with an ignition hole corresponding to the ignition hole of the cylinder seat cover, the external top end of the two paths is provided with a fixed hole and the interior section of the two paths is provided with a piston, the top face of the cylinder seat is a cylinder seat cover which is substantially an arch-shape, and the surrounding of the cylinder seat cover is for the urging of the retractable blocking rod of the valve body, and the circumferential edge of the cylinder seat cover is tapered and at the top face of the cover is an ignition path, and the ignition path is corresponding to the ignition hole and the external hole of the cover body, and the inner top face of the ignition path is provided with two arch-shaped slot which is semi-circular, and the center of the two slots has a discharged through hole and an inlet hole, and when the cylinder rotates, the air hole is driven to the two slots and the discharged through hole and the bottom section of the through hole; the piston is cylindrical and the circular face is provided with a plurality of sealing straps such that the pistons within the path are air-tight, and the external end of the piston is a recess for mounting with a horizontal rotating wheel, the top face of the recess outside the piston is a guiding slot 34 which is corresponding to the securing hole at the top face of the external end of the two path 22.

Yet another object of the present invention is to provide a rotational engine, wherein the circular path of the cylinder seat is either two, three, four, six or eight depending on the capacity of the cylinder seat body and the cylinder seat and the required engine power.

Still another object of the present invention is to provide a rotational engine, wherein the top face of the recess of the piston external end has a guiding slot corresponding to the securing hole of the cylinder seat.

A further object of the present invention is to provide a rotational engine, wherein the bottom face of the cylinder seat has radially mounted recesses for the movement of chill oil so as to reduce the temperature of the cylinder seat.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view of the present invention.

FIG. 2 is a schematic view showing the operation of the rotating engine of the present invention.

FIG. 3 is a sectional view along line 3-3 of FIG. 2 of the present invention.

FIG. 4 is another schematic view showing the operation of the rotating engine of the present invention.

FIG. 5 is a sectional view along line 5-5 of FIG. 4.

FIG. 6 is a schematic view showing a preferred embodiment having four slots and pistons in accordance with the present invention.

FIG. 7 is a schematic view showing the rail seat with extended cylinder seat body so as to extend the powered distance to obtain preferred rotational power in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

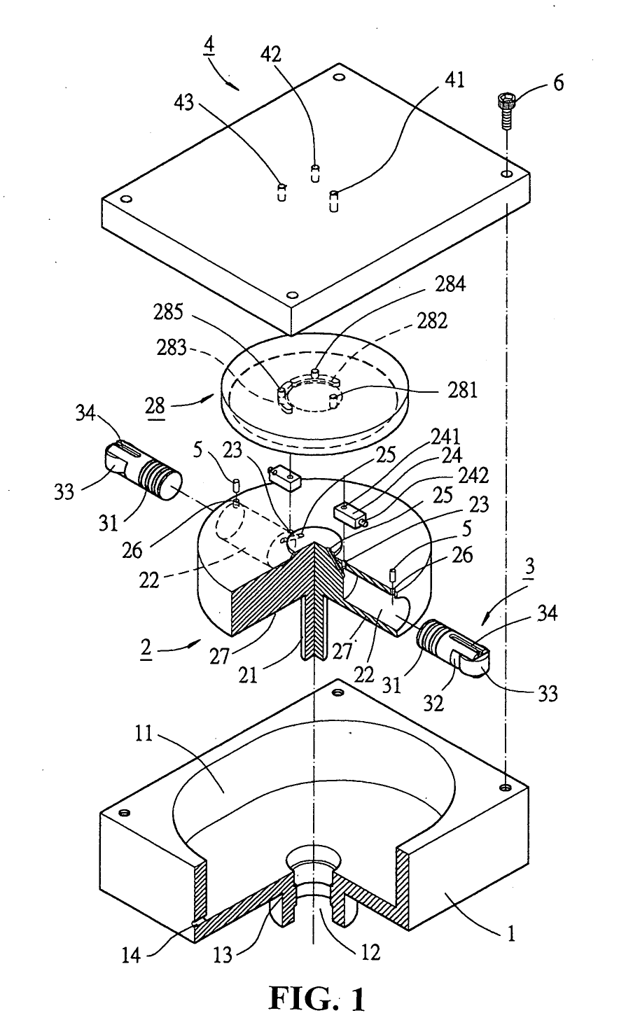

Referring to FIG. 1, the rotational engine comprises a cylinder seat body 1, cylinder seat 2, piston 3 and a cap body 4. The interior of the cylinder seat body 1 is an oval shape railing seat 11 and the center of the railing seat 11 is a hole 12 for the mounting of the shaft 21 of the cylinder set 2 so that the cylinder seat 2 can be placed onto the railing seat 11. The bottom face of the cylinder seat body 1 is provided with an injection hole 13 at the center of the body 1. The injection hole 13 is for the injection of cooling liquid to the slot 27 for cooling of the cylinder seat 2. The side of the bottom face of the cylinder seat body 1 is an oil discharge hole 14 for the discharging of used chilling liquid.

The cylindrical seat 2 is a circular and the bottom section is downwardly extended to form a shaft 21 which can pass through the hole 12 of the railing seat 1. The surrounding of the shaft center is opened outward to two corresponding path 22 and the interior of the path 22 is for the mounting of a piston 3. The top face of the inner end of the two path 22 is provided with an air valve 23, and on the air hole 23, a valve body 24 is provided. A hole 241 is provided on the valve body 24 corresponding to the air-valve 23, and the interior thereof is a retractable blocking rod 242, which can extend to the left and right or retract inward so as to block or open the hole 241 so that the two air holes 23 can discharge air or withdraw air via the hole 241. The inner face of the two paths 22, near to the center of the paths, is provided with an ignition hole 25 corresponding to the ignition path 281. The top face of the outer end of the two paths is provided with a securing hole 28 for mounting of a screw bolt 5. The bottom face of the cylinder seat 2 is a slot 27 radially arranged, and the slot 27 allows the cooling fluid to flow within the slot 27 so as to reduce the heat generated by the cylinder seat 2, and the cooling fluid is discharged via the oil discharging hole 14. Further, the top face of the cylinder seat 2 has a seat cap 28 which is substantially arch shape. At the top face of the cap 28, an ignition path 281 is formed and the path is corresponding to the hole 25 and the path 41. The top face of the cap 28 has two slots 282, 283 and each of the slots 282, 283 has a semi-circular. The center of the slots 282, 283 is a through hole 284 for discharge air and a through hole 285 for inlet air. Due to the fact that the two slots 282, 283, the discharge through hole 284, and the air inlet hole 285 are corresponding to the air hole 23 of the cylinder seat 2 and the hole 241 of the air valve body 24, when the cylinder seat 2 rotates, the air hole 23 and the hole 241 of the air valve body 24 will be brought to the lower section of the two slots 282, 283 and the discharge through hole 284 and the air inlet through hole 285 and will respond to air discharging, air inlet. The surrounding of the cylinder cap 28 can be urged by the retractable blocking rod 242, and the inner face of the surrounding, corresponding to two slots 282, 283, is tapered. In other words, the inner face of the surrounding of the cylinder seat cap 28 corresponding to the slot 282 has a tapered thickness, and the inner face of the surrounding of the cylinder seat cap corresponding to the slot 283 is tapered from a thinner thickness to a thicker thickness. When the retractable blocking rod 242 is fully extended outward. The hole 24 on the air valve body 24 will not be blocked by the blocking rod 242, and the hole 241 and the air hole 23 are in communication. When the blocking rod 242 urges at the inner face of the surrounding with a larger thickness, the blocking rod 242 is urged and becomes inwardly retracted. The hole 241 at the air valve body 24 is blocked and sealed by the inwardly retracted blocking rod 242, and therefore there is no communication between the hole 241 and the air hole 23 and air will not be able to go through via the hole 241 to ensure air incoming and air discharging.

The piston 3 is cylindrical having a plurality of air-sealed stripes 31 along the circumferential face of the inner end, and the air-sealed stripes 31 allow the piston 3 on the path 22 to remain air sealed. The external end face of the piston 3 is provided with a recess 32 and the internal sectional of the recess 32 is a horizontal wheel 33. The top face of the recess 32 at the outer end of the piston 3 is a sliding slot 34 of certain depth which is corresponding to the securing hole 24 at the top face of the external end close to the path 22. Thus, the screw bolt 5 passes through the securing hole 24 to lock to the sliding slot 34 so that the piston 3 is reciprocating in a straight line within the path 22 to ensure the stability of rotating of the horizontal wheel 33 at the outer end of the piston 3.

The cap body 4 is substantially arch-shaped and the screw bolt 5 is mounted on to the top of the cylinder seat body 1 and the cylinder seat body 2 is sealed. On an appropriate position of the cap body 4, an externally connected path 41 is provided and is corresponding to the ignition path 281, which is externally connected to an ignition system. Further, at a piston on the cap body 4 near to the center thereof, a discharge air hole 42 and an air inlet hole 43 are provided. The discharge hole 42 is corresponding to the through hole 284 of the cylinder seat cover 28, and the air inlet hole 43 is corresponding to the air inlet through hole 285, and the air inlet hole 43 is externally connected to a fuel supplying system.

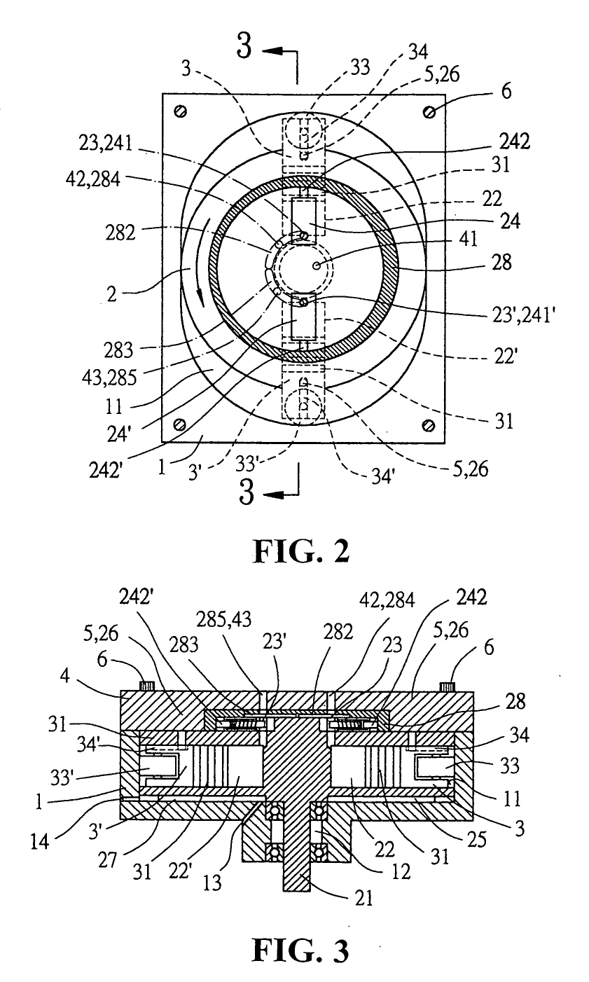

Referring to FIGS. 2 and 3, the rod shaft 21 is positioned below the cylinder seat body 1 for connection to a transmission element so as to drive the cylinder seat 2 to rotate within the railing seat 11, and the piston 3, 3′ within the corresponding path 22, 22′ will also be rotated, and the valve body 24 positioned at the top face of the cylinder seat 2 will also be rotated in accordance with the cylinder seat 2. The piston 3, 3′ also rotates along the surrounding wall of the oval shape railing seat 11 together with the horizontal rotating wheels 33, 33′, as shown in FIG. 2. When the piston 3, 3′ are at the top and bottom extreme of the railing seat 11, the piston 3, 3′ within the path 22, 22′ will extend externally. At this instance, the inner face of the path 22, 22′ will form into a cavity, and the air holes 23, 23′ of the paths 22, 22′ are corresponding to the bottom section of the slots 282, 283. That is, the air hole 23 is corresponding to the lower section of the slot 282. The air hole 23′ is positioned at the lower section of the slot 283, and the retractable blocking rod 242 urged the cylinder seat body 28 has an inwardly retracted inner surrounding. This is because the hole 241 is blocked and is sealed by the blocking rod 242. Thus, the air hole 23 and the discharge through hole 284 of the slot 282 is cut off and air cannot enter into the slot 282. The other air valve body 24′ (due to the blocking rod 242′ urged the thicker circumferential wall of the cylinder seat cap 281 is inwardly retracted, therefore, the hole 24′ is blocked and closed, and the air inlet through hole 285 of the slot 283 is cut off from the air hole 23′ so that air cannot enter the cylinder body. When the cylinder seat 2 rotates clockwise about a specific point, the piston 3, 3′ will move inwardly towards the path 22, 22′. At this instance, the air hole 23′ will dislocate from the lower position of the corresponding slot 283 and the retractable blocking rod 242′ will retract inwardly due to its urging at the thicker inner face of the circumferential side of the cylinder seat cap 28. Thus, the communication of the air hole 23′ and the inlet through hole 285 is cut off. That is, there is no communication between the air hole 23′ and the through hole 285 via the hole 241′. Thus, the air hole 23′ is at a sealed condition, and the space at the inner face of the path 22′ will be inwardly moved as a result of the inward move of the piston 3′. This is the compression distance.

At the same time, the air hole 23 of the path 22 will gradually move to the bottom of the slot 284, and the blocking rod 242 will urge to the inner face of thinner thickness of the circumferential side so that the hole 241 which has been blocked will be gradually opened, and the air hole 23 and the through hole 284 are in communication. At this instance, the piston 3 within the cavity of the path 22 is inwardly moved, air enters through the air hole 23, the hole 241 and is discharged via the slot 282 and the through hole 284, and the discharge air hole 48. This is the air discharge distance.

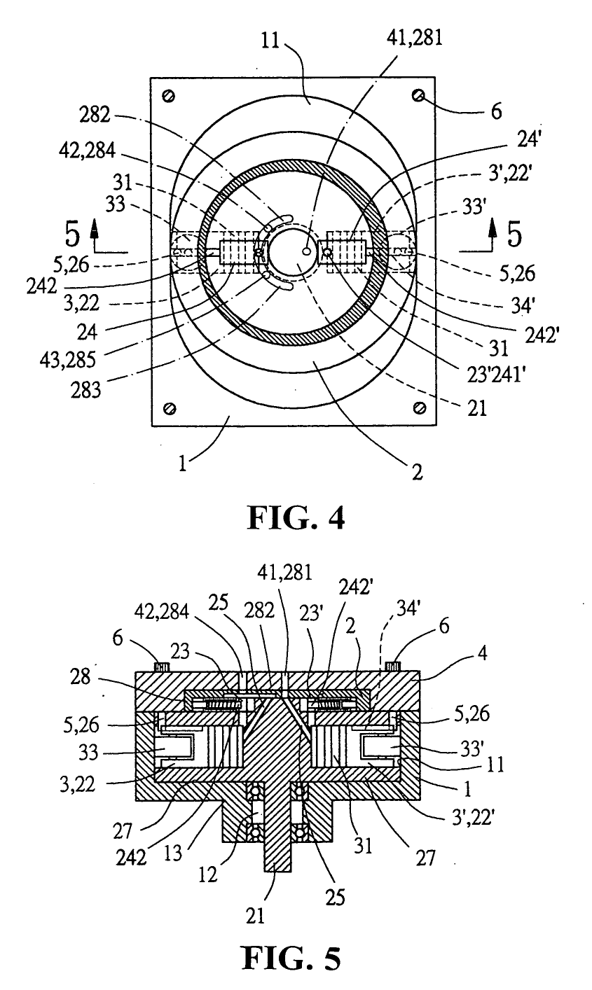

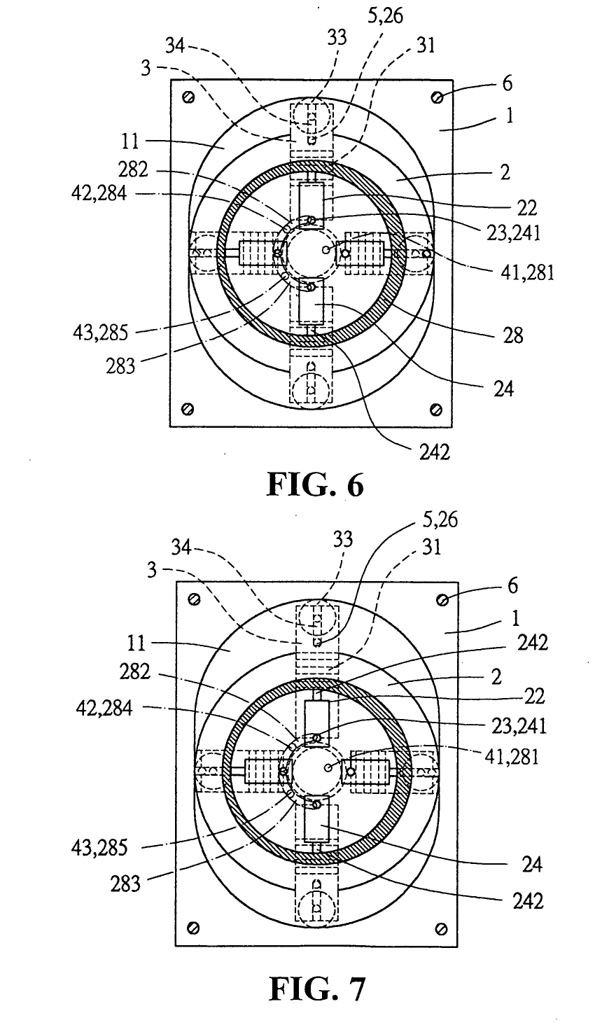

Referring to FIGS. 4 and 5, when the cylinder seat 2 drives the piston 3, 3′ to the left and right end of the railing seat 11, the piston 3, 3 ′ will be affected by the surrounding wall of the elliptical railing seat 11 and the pistons 3, 3′ are moved inwardly into the path 22, 22′. The hole 241′ is blocked by the blocking rod 242′ and therefore, air cannot enter. At this point, the piston 3′ is rotated to the right end from the bottom end so as to ensure air within the path 22′ to be completely compressed (compress distance). When the piston 3′ continuously rotates, the ignition hole 25′ will correspond to the ignition path 281 and the bottom section of the externally connected path 41. At this instance, the ignition system will initiate the ignition process and combustion is triggered and the piston 3′ is pushed backward. In other words, he piston 3′ rotates in accordance with the cylinder seat 2 and is rotated to about 15 degree from the right of the railing seat 11. Thus the piston 3 converts the energy from the back into an energy to drive the cylinder seat 2 to rotate. This is the power distance. In addition, when the air hole 23 rotates from the top end to the right end, the exhaust gas after combustion is discharged via the air hole 23 and the hole 241, the slot 282 and the discharge through hole 284, and is then discharged via the air hole 42 (discharging distance). The retractable blocking rod 242 is fully extended to the top end and the air hole 23, the hole 241, the slot 282 and the through hole 284 are in communication. Thus, the exhausted gas is discharged via the discharge air hole 42. The piston 3 is continuously rotating and the air hole 23 on the path 22 is moved from the position corresponding to the through hole 284 to the bottom section of the through hole 285. The hole 241 is at open situation. The top section of the air hole 43 is provided with a fuse supplying system and the interior of the path 22 is a vacuum. When the piston 3 is rotated to the bottom end of the railing seat 11, the blocking rod 242 is inwardly retracted and the hole 241 is fully blocked. This is air inlet distance. The piston 3 continuously rotates to the compression distance, power distance and air-discharging distance to complete the operation of the engine. Referring to FIG. 6, the interior of the cylinder seat 2 is provided with four two paired corresponding path 22 and the piston 3. The increase of the path 22 and the piston, the power of the engine is increased, and the operation and operational distance have not been changed. In the implementation of the present invention, the power of the engine depends on the number of path 22 and piston 3. The number of path 22 and piston 3 can be two, three, four, six, or eight and in compliance with the capacity of the cylinder body 1 and the cylinder seat 2.

In accordance with the present invention, the piston 3 moves from the left end of the railing seat 11 to the bottom end, and at this instance, the retractable blocking rod 242 of the air valve body 28 urged at the thinner portion of the inner face of the surrounding side is at outward urging condition. The blocking rod 242 cannot seat the hole 241 and the air hole 23 is opened for air inlet. Due to the fact that the interior of the slot 22 becomes a vacuum and the air-fuel mixed gas is sucked into the air hole 43. For compression distance, the piston 3 moves from the bottom end to the right end of the railing seat 11. At this instance, the air hole 23 being blocked by the retractable blocking rod 242 is sealed, and the cavity at the inner face of the path 22 is gradually compressed when the piston 3 is subjected to inward movement for the air-fuel mixed gas. For power distance, the piston 3 moves from right end to the top end. At this instance, the ignition slot 25 of the path 22 is exactly corresponding to the ignition-path 281 and the lower section of the externally connected path 41. However, the ignition system connected to the path 41 can ignite the mixed fuel-air gas within the path 22 of the cylinder seat 2. The combustion of the mixed fuel-air gas will move the piston 3 from the rear section to drive the cylinder seat 2 to rotate. For air discharging distance, the piston 3 moves from the top end to the left end of the failing seat 11. The interior of the path 22 after combustion of mixed fuel-air gas will generate exhausted gas and the retractable blocking rod 242 which gradually urges the thinner inner face of the cylinder seat cap 28 and therefore the hole 241 and the air hole 23 and the discharge through hole 284 are in communication, and the piston 3, when it is compressed at the inner face of the path 22, causes the exhausted gas to be discharged from the air hole 23 via the hole 241, the slot 282 and the through hole 284, and is discharged via the air discharge hole 42.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. A rotational engine comprising:
a cylinder seat body;
a cylinder seat;
a piston; and
a cap body;
wherein an interior of the cylinder seat body is recessed to provide an oval shaped rail seat having a through hole for mounting a shaft of the cylinder seat;
wherein the cylinder seat is circular, having a bottom section downwardly extended for the shaft being inserted into a hole on the oval shaped rail seat;
wherein the surrounding of the shaft center of the cylinder seat is extended to provide two circular paths in parallel and the inner end of the path is provided with an air hole respectively mounted with a valve body;
wherein the valve body has a hole which corresponds to the air hole; and
wherein an interior of the valve body is provided with a retractable blocking rod extending to the left and right or retracted to block and open the air hole for delivering air into an air inlet hole and discharging air through a discharge air hole;
wherein the center position of the two paths is provided with an ignition hole corresponding to the ignition hole corresponding to the ignition hole of the cylinder seat cover, an external top end of the two paths is provided with a fixed hole and an interior section of the two paths is provided with a piston;
wherein a top face of the cylinder seat is a cylinder seat cover which is substantially an arch-shape, and a surrounding of the cylinder seat cover is for urging of the retractable blocking rod of the valve body, and wherein a circumferential edge of the cylinder seat cover is tapered and at the top face of the cover is an ignition path, and the ignition path is corresponding to the ignition hole and an external hole of the cover body, and an inner top face of the ignition path is provided with two arch-shaped slot which is semi-circular, a bottom face of the cylinder seat has radially mounted recesses for movement of chill oil so as to reduce temperature of the cylinder seat; and
wherein a discharged through hole and an inlet hole are provided at a center of the two arch-shaped slots, and when the cylinder rotates, the air hole is driven to the two arch-shaped slots and the discharged through hole and the bottom section of the through hole;
wherein the piston is cylindrical and the circular face is provided with a plurality of sealing straps such that the pistons within the path are air-tight, and the external end of the piston is a recess for mounting with a horizontal rotating wheel;
wherein the top face of the recess outside the piston is a guiding slot which is corresponding to the securing hole at the top face of the external end of the two paths.
